(19) United States
(12) Patent Application Publication
(10) Pub. No.: US 2024/0045493 A1
(43) Pub. Date: Feb. 8, 2024

(54) DATA PROCESSING

(71) Applicant: Rocketmakers Limited, Bath (GB)

(72) Inventors: Richard GODFREY, Bath (GB); Adam WALKER, Bath (GB)

(21) Appl. No.: 18/237,858

(22) Filed: Aug. 24, 2023

Related U.S. Application Data
(63) Continuation of application No. PCT/GB2022/050431, filed on Feb. 17, 2022.

(30) Foreign Application Priority Data
Feb. 26, 2021 (GB) 2102801.4

(51) Int. Cl. G06F 3/01; G06T 15/20

(52) U.S. Cl. CPC G06F 3/011; G06T 15/20; G06T 2200/24

(57) ABSTRACT

A method of processing 3D virtual environment data. The method comprises, at a server: receiving, from a user terminal remote from the server, a request for one or more virtual content assets for use in populating one or more virtual content asset placeholders within a 3D virtual environment being executed on the user terminal; in response to receipt of the request, identifying, for each of the one of more virtual content asset placeholders, at least one virtual content asset that satisfies one or more rules associated with the respective virtual content asset placeholder or the at least one virtual content asset; and transmitting, to the user terminal, data associated with the identified one or more virtual content assets, the transmitted data being operable to cause the user terminal to populate the one or more virtual content asset placeholders in the 3D virtual environment currently being executed on the user terminal.

### CROSS-REFERENCE TO RELATED APPLICATIONS

This Application is a continuation of PCT International Application No. PCT/GB2022/050431, filed Feb. 17, 2022, which claims priority to GB Application No. 2102801.4, filed Feb. 26, 2021, both of which are incorporated by reference herein in their entirety.

### TECHNICAL FIELD

The present disclosure concerns data processing. More particularly, but not exclusively, the present disclosure concerns measures, including method, apparatus and computer program for use in processing 3D virtual environment data.

### BACKGROUND

A three-dimensional (3D) virtual environment comprises a virtual model of a location which a user of the 3D virtual environment can, via a user interface, explore and interact with. A virtual environment may be entirely self-contained (for example, in the case of a virtual reality (VR) experience) or may be supplemented by a real-world environment (for example, in the case of an augmented reality (AR) experience). Such 3D virtual environments are employed in a number of fields for various different applications. For example, 3D virtual environments are employed in computer games, training simulations, virtual museum exhibitions, and virtual shopping experiences.

A design and deployment process for an application including a virtual environment typically involves a publisher (alternatively known as a virtual environment manager, a virtual environment operator, or a virtual environment owner) contracting a developer to produce the application. A publisher will be understood by the skilled person to refer to a person who operates and/or manages a 3D virtual environments (including, for example, 3D and/or immersive experiences). It will be appreciated that the use of the term “publisher” does not require that they necessarily make their 3D virtual environments available to the public at large. Publishers may instead make their 3D virtual environments available only internally and/or privately. The developer generates the underlying code and associated virtual resources for the virtual environment along with any other elements of the application, which are together compiled into a single application. The application is then deployed and, by running the application, end-users can interact with the virtual environment.

However, once an application including a virtual environment has been compiled and deployed, the content of the virtual environment is relatively static and difficult to change. To change the virtual environment, it is necessary to edit the underlying code of the application, and then recompile and redeploy the whole application (for example, by issuing an update to, or a new version of, the application). The application may even need to be re-approved by a distributor of the application. This is a time-consuming and cumbersome process, particularly if only minor changes to the virtual environment are needed. This complexity may, in many cases, preclude minor or frequent changes to a virtual environment. As frequent updates to such virtual environments are often desired to keep end-users engaged, this constraint can negatively impact the popularity and success of a virtual environment.

Furthermore, the publisher of the virtual environment often does not have the resources and skills required to edit the underlying code of the application, recompile it, and then redeploy it. The publisher must, if they want to change the virtual environment in any way, re-employ a developer to make their desired changes.

The present disclosure seeks to mitigate the above-mentioned problems. Alternatively or additionally, the present disclosure seeks to provide improved processing of 3D virtual environment data.

### SUMMARY

According to a first aspect of the present disclosure, there is provided a method of processing 3D virtual environment data, the method comprising, at a server: receiving, from a user terminal remote from the server, a request for one or more virtual content assets for use in populating one or more virtual content asset placeholders within a 3D virtual environment currently being executed on the user terminal; in response to receipt of the request, identifying from a store of virtual content assets, for each of the one of more virtual content asset placeholders, at least one virtual content asset which satisfies one or more rules associated with the respective virtual content asset placeholder or the at least one virtual content asset; and transmitting, to the user terminal, data associated with the identified one or more virtual content assets, the transmitted data being operable to cause the user terminal to populate the one or more virtual content asset placeholders in the 3D virtual environment currently being executed on the user terminal.

According to a second aspect of the present disclosure, there is provided a method of processing 3D virtual environment data, the method comprising, at a user terminal: executing a 3D virtual environment; transmitting, to a remote server, a request for one or more virtual content assets for use in populating one or more virtual content asset placeholders within the 3D virtual environment currently being executed; receiving, from the server, for each of the one or more virtual content asset placeholders, data associated with one or more virtual content assets, the one or more virtual content assets having been identified as satisfying one or more rules associated with the respective virtual content asset placeholder or the at least one virtual content asset; and in response to receipt of the data, populating the one or more virtual content asset placeholders in the 3D virtual environment.

According to a third aspect of the present disclosure, there is provided a computer program comprising a set of instructions, which, when executed by a computerized device, cause the computerized device to perform a method of processing 3D virtual environment data, the method comprising: receiving, from a user terminal remote from the computerized device, a request for one or more virtual content assets for use in populating one or more virtual content asset placeholders within a 3D virtual environment currently being executed on the user terminal; in response to receipt of the request, identifying from a store of virtual content assets, for each of the one of more virtual content asset placeholders, at least one virtual content asset which satisfies one or more rules associated with the respective virtual content asset placeholder or the at least one virtual content asset; and transmitting, to the user terminal, data associated with the identified one or more virtual content assets, the transmitted data being operable to cause the user terminal to populate the one or more virtual content asset placeholders in the 3D virtual environment currently being executed on the user terminal.

According to a fourth aspect of the present disclosure, there is provided a computer program comprising a set of instructions, which, when executed by a computerized device, cause the computerized device to perform a method of processing 3D virtual environment data, the method comprising: executing a 3D virtual environment; transmitting, to a remote server, a request for one or more virtual content assets for use in populating one or more virtual content asset placeholders within the 3D virtual environment currently being executed; receiving, from the server, for each of the one or more virtual content asset placeholders, data associated with one or more virtual content assets, the one or more virtual content assets having been identified as satisfying one or more rules associated with the respective virtual content asset placeholder or the at least one virtual content asset; and in response to receipt of the data, populating the one or more virtual content asset placeholders in the 3D virtual environment.

According to a fifth aspect of the present disclosure, there is provided a server for processing 3D virtual environment data, the server comprising: a receiver module configured to receive, from a user terminal remote from the server, a request for one or more virtual content assets for use in populating one or more virtual content asset placeholders within a 3D virtual environment currently being executed on the user terminal; a content identification module configured to, in response to receipt of the request, identifying from a store of virtual content assets, for each of the one of more virtual content asset placeholders, at least one virtual content asset which satisfies one or more rules associated with the respective virtual content asset placeholder or the at least one virtual content asset; and a transmitter module configured to transmit, to the user terminal, data associated with the identified one or more virtual content assets, the transmitted data being operable to cause the user terminal to populate the one or more virtual content asset placeholders in the 3D virtual environment currently being executed on the user terminal.

According to a sixth aspect of the present disclosure, there is provided a user terminal for processing 3D virtual environment data, the user terminal comprising: a transmitter module configured to transmit, to a remote server, a request for one or more virtual content assets for use in populating one or more virtual content asset placeholders within a 3D virtual environment being executed by the user terminal; a receiver module configured to receive, from the server, for each of the one or more virtual content asset placeholders, data associated with one or more virtual content assets, the one or more virtual content assets having been identified as satisfying one or more rules associated with the respective virtual content asset placeholder or the at least one virtual content asset; and a processing system configured to execute the 3D virtual environment and, in response to receipt of the data, populate the one or more virtual content asset placeholders in the 3D virtual environment.

According to a seventh aspect of the present disclosure, there is provided a system for processing 3D virtual environment data, the system comprising a server and a user terminal remote from the server, wherein: the server comprises: a receiver module configured to receive, from the user terminal, a request for one or more virtual content assets for use in populating one or more virtual content asset placeholders within a 3D virtual environment currently being executed on the user terminal; a content identification module configured to, in response to receipt of the request, identify from a store of virtual content assets, for each of the one of more virtual content asset placeholders, at least one virtual content asset which satisfies one or more rules associated with the respective virtual content asset placeholder or the at least one virtual content asset; and a transmitter module configured to transmit, to the user terminal, data associated with the identified one or more virtual content assets; and the user terminal comprises: a transmitter module configured to transmit the request to the server; a receiver module configured to receive, from the server, the data associated with one or more virtual content assets, and a processing system configured to execute the 3D virtual environment and, in response to receipt of the data, populate the one or more virtual content asset placeholders in the 3D virtual environment.

It will of course be appreciated that features described in relation to one aspect of the present disclosure may be incorporated into other aspects of the present disclosure. For example, the method of the disclosure may incorporate any of the features described with reference to the apparatus of the disclosure and vice versa.

### DESCRIPTION OF THE DRAWINGS

Embodiments of the present disclosure will now be described by way of example only with reference to the accompanying schematic drawings of which:

FIG. 1 shows a schematic view of a system according to embodiments of the present disclosure;

FIG. 2 shows a schematic view of the user terminal of FIG. 1;

FIG. 3 shows a schematic view of the server of FIG. 1;

FIG. 4 shows a flow diagram illustrating the steps of a method according to embodiments of the present disclosure; and

FIG. 5 shows a flow diagram illustrating the steps of a method according to embodiments of the present disclosure.

### DETAILED DESCRIPTION

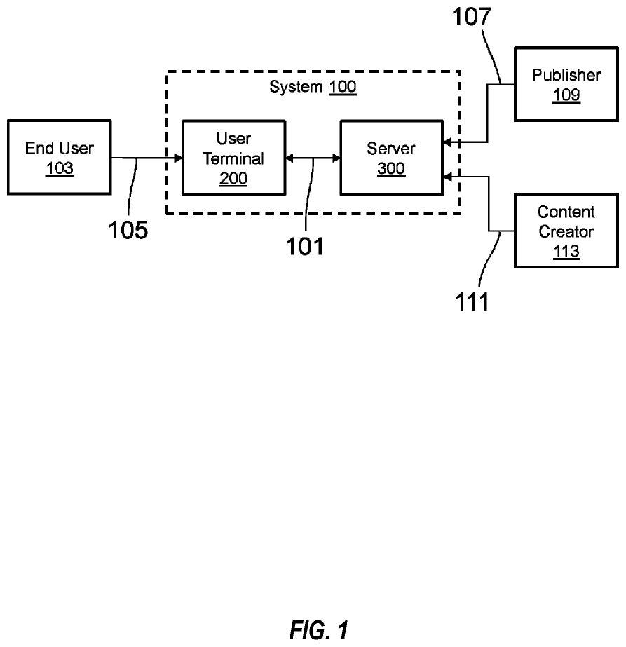

FIG. 1 shows a schematic view of a system 100 for processing 3D virtual environment data according to embodiments of the present disclosure. System 100 comprises user terminal 200 and a server 300.

User terminal 200 and server 300 are connected by a communication link 101, such that information can pass between user terminal 200 and server 300 via communication link 101. In embodiments, communication link 101 comprises a wired communication link. Alternatively or additionally, communication link 101 comprises a wireless communication link. In embodiments, some or all or communication link 101 is carried over a network (for example, the internet). In embodiments, user terminal 200 is located remote from server 300.

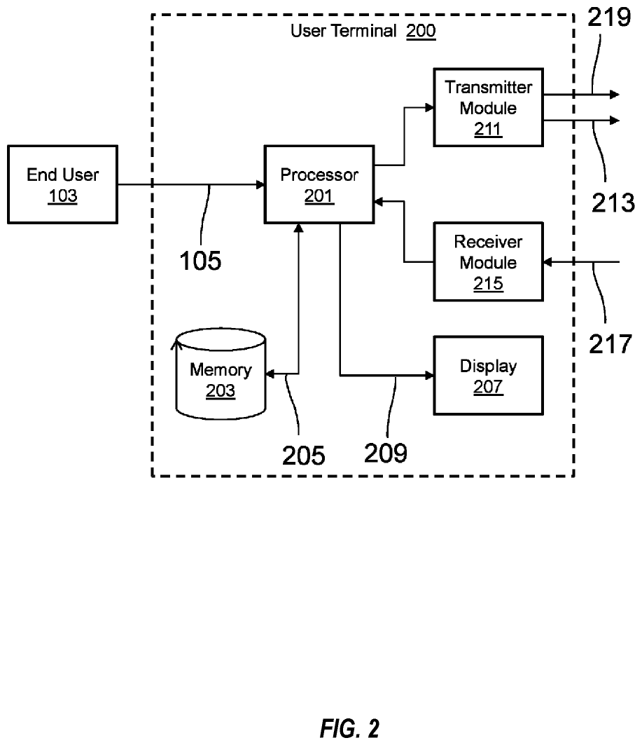

FIG. 2 shows a schematic view of user terminal 200 according to embodiments of the present disclosure. User terminal 200 comprises a processor 201 and associated memory 203. Processor 201 is configured to execute a 3D virtual environment. In embodiments, memory 203 contains a series of instructions 205 which, when executed, cause processor 201 to execute the 3D virtual environment.

It will be appreciated that a 3D virtual environment can comprise a virtual model of a location. The 3D virtual environment may represent a real-world location or a fictional one, and may be entirely self-contained (for example, in the case of a virtual reality (VR) experience) or may be supplemented by a real-world environment (for example, in the case of an augmented reality (AR) experience). In embodiments, the 3D virtual environment comprises one or more of: a virtual reality application, an augmented reality application, a training simulation, and a computer game.

In embodiments, user terminal 200 comprises a display 207. In embodiments, display 207 comprises one or more of: a television, a VR headset display, an AR headset display, a computer monitor, and a touchscreen display (for example, comprised in a smartphone or a tablet computer). In embodiments, processor 201 is configured to generate display data 209 which causes display 207 to present a view of the 3D virtual environment to an end-user 103. An “end-user” will be understood to refer to a player/actor in the 3D virtual environment. In other embodiments, user terminal 200 does not include a display, and instead is configured to transmit display data 209 to a separate display device. In embodiments, generating display data 209 comprises rendering a view of the 3D virtual environment (for example, a view corresponding to a position and orientation of end-user 103 within the 3D virtual environment).

In embodiments, processor 201 is configured to receive user input 105 from end-user 103 (for example, via a user input device such as a keyboard, mouse, gaming controller, VR headset, or AR headset). In such embodiments, user input 105 may comprise commands to move about in or interact with the 3D virtual environment. Thus, in embodiments, the 3D virtual environment is configured to allow end-user 103 to interact with one or more aspects of or elements within the 3D virtual environment. Thus, in embodiments, executing the 3D virtual environment comprises receiving and processing user input 105 to determine one or more actions by end-user 103 within the 3D virtual environment. Such actions may, for example, include movement of the end-user within the 3D virtual environment or manipulation of a virtual object within the 3D virtual environment. In such embodiments, it may be that executing the 3D virtual environment comprises updating a state of the 3D virtual environment in response to the determined one or more actions. In embodiments, updating the state of the 3D virtual environment may comprise generating updated display data 209.

The 3D virtual environment contains one or more virtual content asset placeholders. A virtual content asset placeholder comprises a virtual identifier of a location or marker within the 3D virtual environment which is configured to host an, as yet undetermined, virtual content asset. Virtual content assets can, for example, include 3D virtual object data, image data, text data, audio data, or video data. For example, the virtual content asset may be a virtual object to be placed within the 3D virtual environment. As a further example, the virtual content asset may comprise a PDF document (i.e. text and/or image data). In embodiments, video and audio data can comprise spatial audio and/or video data. In embodiments, video data can comprise 360° video data. In embodiments, text data can comprise a link (for example, URLs) to external content (for example, to external web sites).

In embodiments, a virtual content asset placeholder may define a volume (for example, to accommodate a virtual content asset comprising 3D virtual object data), a surface (for example, to accommodate a virtual content asset comprising image or video data), or a point within the 3D virtual environment (for example, to accommodate a virtual content asset comprising audio data).

In embodiments, a virtual content asset placeholder is not associated with a particular location, but is instead associated with an event or other trigger within the 3D virtual environment (for example, a certain action by end-user 103). For example, a virtual content asset placeholder for audio data may be associated with a trigger action by end-user 103, such that the audio data (the virtual content asset) which is used to populate that virtual content asset placeholder is played in response to end-user 103 performing the trigger action.

User terminal 200 further comprises a transmitter module 211. Transmitter module 211 is configured to transmit, to server 300, a request 213 for one or more virtual content assets for use in populating the one or more virtual content asset placeholders within the 3D virtual environment being executed by user terminal 200.

In embodiments, request 213 comprises an identifier (for example, a unique reference number or alphanumeric string) of a virtual content asset placeholder. In other embodiments, request 213 comprises a definition of the virtual content asset placeholder. In such embodiments, it may be that request 213 comprises one or more features of the virtual content asset placeholder (for example, the type of virtual content asset(s) it can accommodate, a size of the virtual content asset placeholder, and/or an identification of the 3D virtual environment hosting the virtual content asset placeholder).

In embodiments, transmitter module 211 is configured to transmit the request in response to one or more of: the executing of the 3D virtual environment, a proximity in the 3D virtual environment of end-user 103 to a virtual content asset placeholder, engagement by end-user 103 with a virtual content asset (for example, end-user 103 looking at the virtual content asset), and an interaction by end-user 103 with the 3D virtual environment (for example, end-user 103 pressing a button in the 3D virtual environment).

User terminal 200 further comprises a receiver module 215. Receiver module 215 is configured to receive, from server 300, for each of the one or more virtual content asset placeholders, data 217 associated with one or more virtual content assets. In embodiments, data 217 comprises a data file (for example, a Joint Photographic Experts Group (JPEG) image file, an MPEG Audio Layer-3 (MP3) audio file, or an MPEG-4 Advanced Video Coding (MP4) video file) containing the virtual content asset. In embodiments, data 217 comprises an identifier (for example, one or more Uniform Resource Locators (URL)) associated with the one or more virtual content assets. In such embodiments, it may be that processor 201 is configured to use the identifier to retrieve the one or more virtual content assets.

Processor 201 is configured to, in response to receipt of data 217, populate the one or more virtual content asset placeholders in the 3D virtual environment. In embodiments, populating the one or more virtual content asset placeholders comprises inserting a virtual content asset into the location or event associated with a virtual content asset placeholder. In embodiments, populating the one or more virtual content asset placeholders comprises, for each of the one or more virtual content asset placeholders, inserting a respective virtual content asset into the location or event associated with the virtual content asset placeholder. In embodiments, more than one virtual content asset populates a single virtual content asset placeholder. In other embodiments, only a single virtual content asset populates a single virtual content placeholder. In embodiments, the 3D virtual environment includes multiple instances of a given virtual content asset placeholder. In such embodiments, data 217 may indicate a single virtual content asset to be used to populate multiple instances of the virtual content asset placeholder.

Thus, in embodiments, executing the 3D virtual environment comprises populating the one or more virtual content asset placeholders. In such embodiments, it may be that executing the 3D virtual environment comprises displaying the 3D virtual environment (for example, on display 207), including the one or more virtual content assets associated with data 217.

In embodiments, processor 201 is further configured to monitor engagement by end-user 103 with virtual content assets within the 3D environment. In such embodiments, “engagement” by end-user 103 with a virtual content asset refers to a level of attention paid by end-user 103 to the virtual content asset. For example, end-user 103 may engage with a virtual content asset by looking at the virtual content asset. In such embodiments, it may be that transmitter module 211 is configured to, in response to the monitoring, transmit, to server 300, data 219 associated with the engagement. In another example, end-user 103 may engage with a virtual content asset comprising spatial audio data by listening to the resulting audio. In such a case, it may be that the engagement of end-user 103 with the virtual content is inferred based on a position of end-user 103 in relation to one or more sources associated with the spatial audio virtual content asset.

In embodiments, monitoring engagement comprises monitoring for end-user 103 looking at a virtual content asset. In such embodiments, it may be that data 219 comprises a binary indication of whether end-user 103 looked at the virtual content asset. Alternatively or additionally, data 219 may comprise an indication of the length of time for which end-user 103 looked at the virtual content asset. In embodiments, processor 201 is configured to perform gaze-tracking of end-user 103 in order to identify engagement by end-user 103 with virtual content assets.

In embodiments, monitoring engagement comprises monitoring for end-user 103 interacting with the virtual content asset. In such embodiments, “interaction” refers to end-user 103 performing an action on a virtual content asset. Such actions may, for example, include one or more of: touching the virtual content asset, picking up or holding the virtual content asset, rotating or otherwise manipulating the virtual content asset, and providing, in the 3D virtual environment, user input associated with the virtual content asset (for example, by pressing a virtual button to begin playback of a virtual content asset comprising video and/or audio data). In such embodiments, it may be that data 219 comprises a binary indication of whether end-user 103 interacted with the virtual content asset. Alternatively or additionally, data 219 may comprise an indication of the length of time for which end-user 103 interacted with the virtual content asset. In embodiments, data 219 comprises information on the type of the interaction (for example, whether the virtual content asset was picked up or activated). In embodiments, processor 201 is configured to determine a quantified measure of the quality of the engagement and data 219 comprises the determined measure.

In embodiments, monitoring engagement comprises monitoring for end-user 103 performing an action associated with the virtual content asset outside the 3D virtual environment. For example, where a virtual content asset relates to a product, the action may comprise purchasing the product on a website external to the 3D virtual environment. As another example, where the virtual content asset relates to a model of car, the action may comprise booking a test-drive of that model of car on a web site external to the 3D virtual environment.

In embodiments, monitoring engagement comprises monitoring a location of end-user 103 within the 3D virtual environment. In such embodiments, data 219 may comprise coordinate data corresponding to a location within the 3D virtual environment. In embodiments, processor 201 is configured to infer engagement with a virtual content asset on the basis of end-user 103 being in the vicinity of the virtual content asset for at least a predetermined period of time. In embodiments, processor 201 is configured to monitor a location of end-user 103 at the time of one or more specific actions (for example, by end-user 103) or events. In embodiments, data 219 comprises an indication of multiple locations within the 3D virtual environment (for example, locations corresponding to end-user 103 at the respective times of the specific actions or events). Such locations may be defined as absolute locations within the 3D virtual environment, or may be defined relative to one or more virtual content asset placeholders.

In embodiments, transmitter module 211 is configured to transmit data 219 as it is generated. Thus, in embodiments, the transmission of data 219 is performed in response to engagement by end-user 103 with a virtual content asset. In embodiments, transmitter module 211 is configured to transmit data 219 periodically (for example, at regular time intervals). In embodiments, transmitter module 211 is configured to transmit data 219 in response to certain events within the 3D virtual environment (for example, end-user 103 moving between distinct areas of the 3D virtual environment).

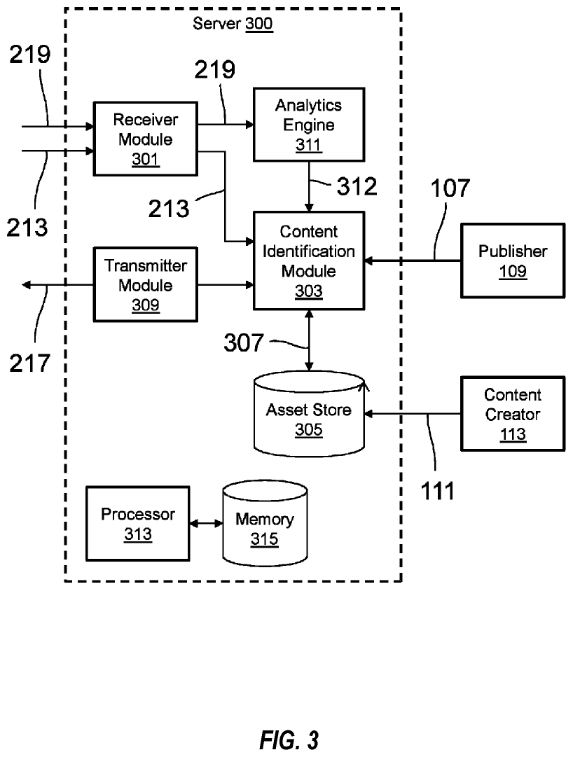

FIG. 3 shows a schematic view of server 300 according to embodiments of the present disclosure. Server 300 comprises a receiver module 301. Receiver module 301 is configured to receive request 213. Thus, receiver module 301 is configured to receive, from user terminal 200, a request for one or more virtual content assets for use in populating one or more virtual content asset placeholders within a 3D virtual environment currently being executed on user terminal 200.

Request 213 is passed to content identification module 303. Content identification module 303 is configured to, in response to receipt of request 213, identify, for each of the one or more virtual content asset placeholders, at least one virtual content asset to populate the virtual content asset placeholder (thereby satisfying request 213).

Server 300 further comprises a store 305 of virtual content assets. In embodiments, asset store 305 is configured to provide a repository of virtual content assets for use in populating virtual content asset placeholders. In embodiments, asset store 305 contains a plurality of virtual content assets. In other embodiments, asset store 305 contains information identifying a plurality of virtual content assets along locations from where the virtual content assets can be retrieved. Content identification module 303 is configured to identify the at least one virtual content asset from asset store 305. Thus, in embodiments, asset store 305 is configured to transmit virtual content asset data 307 to content identification module 303.

In embodiments, server 300 is configured to receive user input 111 from a content creator 113. In embodiments, user input 111 comprises an instruction to add a virtual content asset to asset store 305. In embodiments, the instruction includes a definition of the new virtual content asset. Thus, in embodiments, server 300 is configured to, in response to receipt of user input 111 indicating a new virtual content asset, add the indicated new virtual content asset to asset store 305. In embodiments, user input 111 comprises an instruction to delete a virtual content asset from asset store 305. Thus, in embodiments, server 300 is configured to, in response to receipt of user input 111 indicating a virtual content asset for deletion from asset store 305, delete the indicated virtual content asset from asset store 305.

Content identification module 303 is configured to identify the at least one virtual content asset to satisfy one or more rules associated with the respective virtual content asset placeholder or the at least one virtual content asset. Thus, in embodiments, content identification module 303 is configured to identify only virtual content assets which comply with the one or more rules.

As previously mentioned, in embodiments, request 213 comprises data identifying the one or more virtual content asset placeholders (for example, a list of unique reference numbers or alphanumeric strings associated with the one or more virtual content asset placeholders). In such embodiments, it may be that content identification module 303 is configured to, in response to receipt of request 213, retrieve, from a database, the one or more rules associated with the identified one or more virtual content asset placeholders. In embodiments, the identifying of the one or more virtual content assets is performed in response to the retrieval of the one or more rules. Thus, in embodiments, content identification module 303 is configured to maintain a database of rules. In embodiments, content identification module 303 is further configured to receive user input 107 from a publisher 109. In such embodiments, it may be that user input 107 indicates one or more virtual content asset placeholders and defines the one or more rules. In embodiments, content identification module 303 is configured to associate the defined one or more rules with the indicated one or more virtual content asset placeholders. In embodiments, user input 107 comprises an indication of one or more virtual content asset placeholders, an indication of one or more rules, and a command to disassociate the indicated one or more rules from the indicated one or more virtual content asset placeholders. In such embodiments, it may be that content identification module 303 is configured to disassociate the indicated one or more rules from the indicated one or more virtual content asset placeholders. In embodiments, user input 107 comprises a deletion command and an indication of one or more rules within the database. In such embodiments, content identification module 303 may be configured to, in response to receipt of the instruction, delete the indicated one or more rules. Thus, publisher 109 is provided with means to amend the database of rules.

In embodiments, the one or more rules are associated with a profile of an end-user. For example, a rule may require that a virtual content asset placeholder be populated by a given virtual content asset only for end-users from a specific country, or who are using a certain language. It will be appreciated by the skilled person that any number of other attributes of end-users may be the subject of a rule. For example, such attributes may include: a location of the end-user, a language of the end-user, a type of device on which the 3D virtual environment is running, a total length of time spent in the 3D virtual environment, a skill level of the end-user (for example, where the 3D virtual environment comprises a computing game), or a notional group to which the end-user has been assigned by the publisher. The profile of an end-user may also include data associated with one or more previous actions by an end-user (either within or external to the 3D virtual environment). For example, an end-user's profile may include data on previous purchases or internet searches performed by the end-user. The profile of an end-user may also include data on user terminal 200 (or another system by which the end-user is using or has previously used to run the 3D virtual environment).

In embodiments, the one or more rules are associated with characteristics of user terminal 200. For example, the one or more rules may be associated with an operating system of user terminal 200, or with the hardware specification of user terminal 200.

In embodiments, the one or more rules are associated with historical behavior of an end-user. In such embodiments, it may be that one or more rules are associated with historical behavior of end-users having similar profiles to a current end-user. It may be that one or more rules are associated with historical behavior of end-users having similar engagement patterns to a current end-user.

In embodiments, the one or more rules are associated with a characteristic of the one or more virtual content assets. For example, a rule may dictate that a placeholder must only be populated using virtual content assets which are of a certain data type (e.g., 3D object data, video data, audio data, etc.), which comply with predetermined constraints on the dimensions of the virtual content asset, or which are associated with a user-defined tag. Such a user-defined tag may for example, indicate a type of object represented by the virtual content asset (for example, a virtual content asset representing a car may be associated with a “Car” tag), a theme of the virtual content asset (for example, a virtual content asset representing a jack-o′-lantern may be associated with a “Halloween” tag), or the identity of a creator of the virtual content asset. For example, a virtual content asset placeholder positioned on a street in the 3D virtual environment may be associated with a rule specifying that the virtual content asset placeholder may only be populated by virtual content assets tagged as “cars”.

In embodiments, the one or more rules are associated with a characteristic of the one or more virtual content asset placeholders. For example, a rule may require that a given virtual content asset is only to be used to populate certain virtual content asset placeholders, or only virtual content asset placeholders in certain 3D virtual environments.

In embodiments, the one or more rules are associated with a date and/or time of the request. In embodiments, the data and/or time of the request is that at a location of user terminal 200. Thus, in embodiments, the virtual content assets are identified at least partly based on the time of day or the time of the year at which the request was transmitted. For example, a rule may require that a virtual content asset comprising 3D object data representing a jack-o′-lantern is only used to populate virtual content asset placeholders in the week immediately preceding Halloween.

In embodiments, content identification module 303 is configured to identify the at least one virtual content asset to satisfy one or more further rules associated with the virtual content asset. For example, the virtual content asset may be associated with a rule requiring that the virtual content asset be used to populate virtual content asset placeholders only when certain conditions are met. Such conditions may include constraints on the time of request 213, a date of request 213, one or more user-defined tags associated with the virtual content asset, a language in use by end-user 103, a location of end-user 103, or other characteristics of a profile of end-user 103.

In embodiments, one or more of the virtual content assets with asset store 305 is associated with at least one tag (for example, indicating an item represented by the virtual content asset). Thus, an example virtual content asset comprising 3D object data representing a chair can be associated with a “chair” tag. Such an example virtual content asset may also be associated with a “furniture” tag. In such embodiments, it may be that content identification module 303 is configured to identify the at least one virtual content asset at least partly on the basis of the at least one tag. In embodiments, the one or more rules include at least one rule associated with the at least one tag.

In embodiments, the one or more rules (and optionally also the one or more further rules) are each associated with a priority. In such embodiments, it may be that content identification module 303 is configured to identify the at least one virtual content asset at least partly based on the priority levels of one or more rules. For example, where compliance with all of the one or more rules is not possible, a rule having a relatively high priority may take precedence over a rule having a relatively lower priority.

In embodiments, the identifying comprises identifying a first virtual content asset and a second virtual content asset. In embodiments, the identifying of the second virtual content asset is dependent on the identifying of the first virtual content asset. For example, in embodiments, the 3D virtual environment includes one or more inter-related virtual content asset placeholders. In embodiments, the identification of a virtual content asset for one of the inter-related virtual content asset placeholders is performed at least partly on the basis of a virtual content asset previously identified for another of the inter-related virtual content asset placeholders. Thus, such embodiments can enable virtual content assets to be identified so as to match or complement one another. For example, a 3D virtual environment may include a first virtual content asset placeholder intended to accommodate a virtual content asset comprising a table and a second virtual content asset placeholder intended to accommodate a virtual content asset comprising a chair. By selecting the virtual content asset for the second virtual content asset placeholder based at least in part of a virtual content asset already selected for the first virtual content asset placeholder, it is possible to ensure that a complementary or matching table and chair are identified.

Server 300 further comprises transmitter module 309. Transmitter module 309 is configured to transmit, to user terminal 200, data 217. Thus, transmitter module 309 is configured to transmit, to user terminal 200, data associated with the identified one or more virtual content assets, the transmitted data being operable to cause user terminal 200 to populate the one or more virtual content asset placeholders in the 3D virtual environment currently being executed on user terminal 200.

Thus, system 100 facilitates quick and easy customization of a 3D virtual environment by allowing virtual content assets to be dynamically inserted into the 3D virtual environment application at runtime. This allows content within the 3D virtual environment to be managed dynamically, with no need to re-employ developers and no need to redeploy or update the overall application. System 100 provides publishers and content creators with greater and more flexible control over the 3D virtual environment, allowing them to update, redesign, optimize and personalize the 3D virtual environment after their application has been released.

In embodiments, an analytics engine 311 is configured to receive (via receiver module 301) data 219 from user terminal 200. Thus, in embodiments, receiver module 301 is configured to receive, from user terminal 200, data associated with engagement of end-user 103 (henceforth referred to as engagement data) with virtual content assets (including previously identified virtual content assets) within the 3D virtual environment. In embodiments, analytics engine 311 is configured to monitor engagement with virtual content assets. In embodiments, analytics engine 311 is configured to maintain one or more metrics defining engagement with virtual content assets. Such metrics may include one or more of: counters (for example, of a number of times a virtual content asset is interacted with), timers (for example, of a duration of time a virtual content asset is interacted with), and numerical values (for example, representing a level of attention paid by an end-user to a virtual content asset). In embodiments, such metrics may be used in the one or more rules. Thus, in such embodiments, the one or more rules are associated with one or more metrics of user engagement determined by analytics engine 311.

In embodiments, analytics engine 311 is configured to, on the basis of the received data 219, transmit an instruction 312 to content identification module 303 to adapt the one or more rules. In embodiments, the adapting comprises associating an additional rule with a virtual content asset placeholder. In embodiments, the adapting comprises disassociating a rule from a virtual content asset placeholder. For example, in response to data 219 indicating that a populated virtual content asset is receiving abnormally high levels of attention (implying that the virtual content asset is potentially out of place in its current virtual content asset placeholder), analytics engine 311 may be configured to instruct content identification module 303 to associate an additional rule with the virtual content asset placeholder precluding use of that particular virtual content asset to populate that virtual content asset placeholder. As a further example, in response to data 219 indicating that a populated virtual content asset is receiving abnormally low levels of attention (implying that the virtual content asset is not particularly noticeable in its current virtual content asset placeholder), analytics engine 311 may be configured to instruct content identification module 303 to associate an additional rule with the virtual content asset placeholder precluding use of that particular virtual content asset to populate that virtual content asset placeholder. As a yet further example, data 219 may indicate that, following the association of an addition rule with a virtual content asset placeholder, engagement with virtual content assets used to populate that placeholder has unexpectedly decreased significantly. In such a case, analytics engine 311 may be configured to instruct content identification module 303 to disassociate the new rule from the virtual content asset placeholder.

In response to receipt of instruction 312, content identification module 303 is configured to adapt the one or more rules as indicated by instruction 312. Thus, analytics engine 311 can be said to be configured to, on the basis of the received data 219, adapt the one or more rules.

In embodiments, the receiving of data 219 and the adapting of the one or more rules are performed whilst the 3D virtual environment is being executed on user terminal 200. Thus, in such embodiments, the adapting of the one or more rules can be said to be performed during runtime.

In embodiments, receiver module 301 is configured to receive a further request for one or more further virtual content assets for use in populating one or more further virtual content asset placeholders within the 3D virtual environment. In embodiments, server 300 is configured to repeat the receiving, the identifying, and the transmitting in respect of the further request. In such embodiments, it may be that the identifying performed in respect of the further request is performed on the basis of the adapted one or more rules. Thus, in embodiments, the one or more rules are adapted, based on the behavior of a first end-user, to improve the identification of virtual content assets for a subsequent second end-user.

In embodiments, analytics engine 311 is further configured to generate one or more human-readable reports on the monitored engagement. For example, the one or more reports may include a report indicating average engagement with virtual content assets by one or more end-users. Such reports may be transmitted to one or both of publisher 109 and content creator 113.

In embodiments, the identifying performed in respect of the further request is performed at least partly on the basis of one or more previously identified virtual content assets. Thus, in embodiments, the identifying of the one or more further virtual content assets is performed at least partly based on the one or more virtual assets identified in respect of a previous request.

In embodiments, the one or more rules are determined by a machine learning agent. In such embodiments, it may be that the adapting of the one or more rules is also performed by the machine learning agent.

Server 300 also comprises a processor 313 and an associated memory 315. In embodiment, processor 313 and memory 315 together implement the functionality of one or more (for example, all) of receiver module 301, content identification module 303, transmitter module 309, and analytics engine 311. In such embodiments, it may be that memory 315 contains computer executable instructions which, when executed by processor 313, cause processor 313 to perform that functionality. In embodiments, memory 315 is configured to provide one or both of asset store 305 and the database of rules.

Whilst, in FIGS. 2 and 3, request 213, data 217, and data 219 are illustrated separately, it will be appreciated that, in embodiments, two or more (for example, all) of request 213, data 217, and data 219 are transmitted over the same communication link (for example, communication link 101).

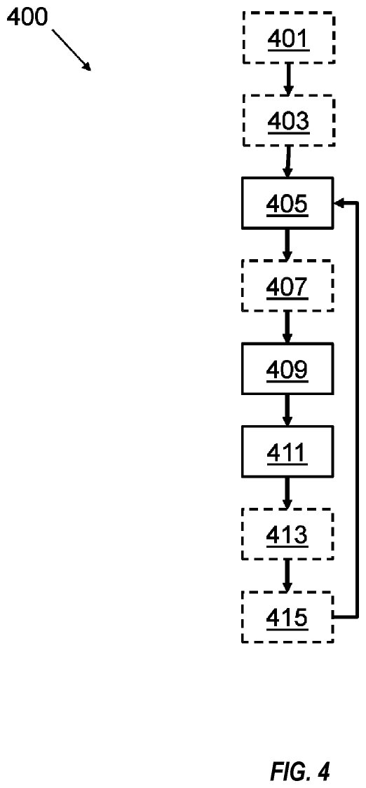

FIG. 4 shows a flow diagram illustrating the steps of a method 400 of processing 3D virtual environment data according to embodiments of the present disclosure. Method 400 is performed at a server (for example, server 300).

An optional first step of method 400, represented by item 401, comprises receiving user input indicating the one or more virtual content asset placeholders and defining one or more rules.

An optional second step of method 400, represented by item 403, comprises, in response to receipt of the user input, associating the one or more rules with the one or more virtual content asset placeholders.

A third step of method 400, represented by item 405, comprises receiving, from a user terminal remote from the server, a request for one or more virtual content assets for use in populating one or more virtual content asset placeholders within a 3D virtual environment currently being executed on the user terminal. In embodiments, the request comprises data identifying the one or more virtual content asset placeholders. In embodiments, the 3D virtual environment comprises one or more of: a virtual reality application, an augmented reality application, a mixed reality application, and a 3D application for display on a 2D display. In embodiments, the 3D virtual environment comprises one or more of: an entertainment experience, an educational experience, a training simulation, and a computer game.

An optional fourth step of method 400, represented by item 407, comprises, in response to receipt of the request, retrieving, from a database, the one or more rules associated with the identified one or more virtual content asset placeholders, wherein the identifying is performed in response to the retrieval.

A fifth step of method 400, represented by item 409, comprises, in response to receipt of the request, identifying from a store of virtual content assets, for each of the one of more virtual content asset placeholders, at least one virtual content asset which satisfies one or more rules associated with the respective virtual content asset placeholder or the at least one virtual content asset. In embodiments, the identifying comprises identifying a first virtual content asset and a second virtual content asset. In such embodiments, it may be that the identifying of the second virtual content asset is dependent on the identifying of the first virtual content asset.

In embodiments, the one or more rules are associated with one or more of: a profile of an end-user, a characteristic of the one or more virtual content assets, a characteristic of the one or more virtual content asset placeholders, and a date and/or time of the request. In embodiments, the at least one virtual content asset comprises one or more of: 3D virtual object data, image data, text data, audio data, and video data. For example, the at least one virtual content asset may comprise a PDF document (i.e. text and/or image data). In embodiments, the at least one virtual content asset comprises spatial audio and/or video data. In embodiments, the at least one virtual content asset comprises 360° video data. In embodiments, the at least one virtual content asset comprises metadata (for example, a link to external content).

A sixth step of method 400, represented by item 411, comprises transmitting, to the user terminal, data associated with the identified one or more virtual content assets, the transmitted data being operable to cause the user terminal to populate the one or more virtual content asset placeholders in the 3D virtual environment currently being executed on the user terminal.

An optional seventh step of method 400, represented by item 413, comprises receiving, from the user terminal, data associated with engagement of an end-user with the at least one virtual content asset within the 3D virtual environment. In embodiments, the engagement data is associated with one or more of: the end-user looking at the virtual content asset, the end-user interacting with the virtual content asset, and a location of the end-user within the virtual environment. In embodiments, the receiving of the engagement data is performed whilst the 3D virtual environment is being executed on the user terminal.

An optional eighth step of method 400, represented by item 415, comprises, on the basis of the received engagement data, adapting the one or more rules. In embodiments, the adapting comprises associating an additional rule with a virtual content asset placeholder. In embodiments, the adapting comprises disassociating a rule from a virtual content asset placeholder. In embodiments, the adapting is performed whilst the 3D virtual environment is being executed on the user terminal.

In embodiments, method 400 comprises repeating the receiving, the identifying, and the transmitting in respect of a further request for one or more further virtual content assets for use in populating one or more further virtual content asset placeholders within the 3D virtual environment. In such embodiments, it may be that the identifying performed in respect of the further request is performed on the basis of the adapted one or more rules. In embodiments, the identifying in respect of the further request is performed at least partly on the basis of one or more previously identified virtual content assets.

In embodiments, method 400 comprises comprising determining the one or more rules by operating a machine learning agent. In such embodiments, it may be that the adapting of the one or more rules is performed by the machine learning agent.

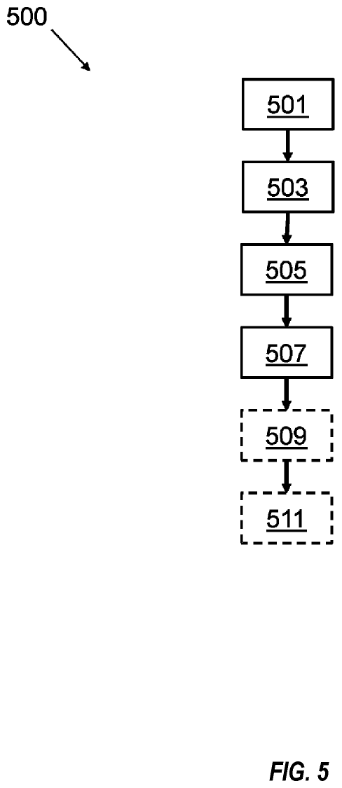

FIG. 5 shows a flow diagram illustrating the steps of a method 500 of processing 3D virtual environment data according to embodiments of the present disclosure. Method 500 is performed at a user terminal (for example, user terminal 200).

A first step of method 500, represented by item 501, comprises executing a 3D virtual environment.

A second step of method 500, represented by item 503, comprises transmitting, to a remote server, a request for one or more virtual content assets for use in populating one or more virtual content asset placeholders within the 3D virtual environment currently being executed. In embodiments, the transmitting of the request is performed in response to one or more of: the executing of the 3D virtual environment, a proximity in the 3D virtual environment of an end-user to a virtual content asset placeholder, engagement by the end-user with a virtual content asset, and an interaction by the end-user with the 3D virtual environment.

A third step of method 500, represented by item 505, comprises receiving, from the server, for each of the one or more virtual content asset placeholders, data associated with one or more virtual content assets, the one or more virtual content assets having been identified as satisfying one or more rules associated with the respective virtual content asset placeholder or the at least one virtual content asset.

A fourth step of method 500, represented by item 507, comprises, in response to receipt of the data, populating the one or more virtual content asset placeholders in the 3D virtual environment.

An optional fifth step of method 500, represented by item 509, comprises monitoring engagement by the end-user with virtual content assets within the 3D environment.

An optional sixth step of method 500, represented by item 511, comprises, in response to the monitoring, transmitting, to the server, data associated with the engagement.

In embodiments, the user terminal comprises a display. In such embodiments, it may be that, the executing and populating comprise displaying the 3D virtual environment, including the identified one or more virtual content assets, on the display.

Whilst the present disclosure has been described and illustrated with reference to particular embodiments, it will be appreciated by those of ordinary skill in the art that the disclosure lends itself to many different variations not specifically illustrated herein. By way of example only, certain possible variations will now be described.

Whilst, in the embodiments illustrated in FIGS. 1 to 3, system 100 comprises a user terminal 200 and server 300, in alternative embodiments the functionality of user terminal 200 and/or server 300 may be divided between multiple computing devices. For example, in embodiments, display 207 may be separate from user terminal 200. In such embodiments, it may be that user terminal 200 is configured to transmit display data to the separate display. Similarly, in embodiments, analytics engine 311 is provided by a separate computing device from that providing content identification module 303.

It will be appreciated by the skilled person that user input 107 from publisher 109 and user input 111 from content creator 113 need not be provided directly into server 300, and may instead be provided by one or more remote computing devices via a communication network (for example, the internet).

Whilst in the embodiments described above, user terminal 200 is located remote from server 300, the need not necessarily be the case. In embodiments, user terminal 200 is located locally to server 300 (for example, in the same building).

Thus, embodiments of the present disclosure provide a method (along with a computer program and a server configured to perform the method) of processing 3D virtual environment data, the method comprising, at a server: receiving, from a user terminal, a request for one or more virtual content assets for use in populating one or more virtual content asset placeholders within a 3D virtual environment currently being executed on the user terminal; in response to receipt of the request, identifying from a store of virtual content assets, for each of the one of more virtual content asset placeholders, at least one virtual content asset which satisfies one or more rules associated with the respective virtual content asset placeholder or the at least one virtual content asset; and transmitting, to the user terminal, data associated with the identified one or more virtual content assets, the transmitted data being operable to cause the user terminal to populate the one or more virtual content asset placeholders in the 3D virtual environment currently being executed on the user terminal.

Thus, embodiments of the present disclosure provide a method (along with a computer program and a user terminal configured to perform the method) of processing 3D virtual environment data, the method comprising, at a user terminal: executing a 3D virtual environment; transmitting, to a remote server, a request for one or more virtual content assets for use in populating one or more virtual content asset placeholders within the 3D virtual environment currently being executed; receiving, from the server, for each of the one or more virtual content asset placeholders, data associated with one or more virtual content assets, the one or more virtual content assets having been identified as satisfying one or more rules associated with the respective virtual content asset placeholder or the at least one virtual content asset; and in response to receipt of the data, populating the one or more virtual content asset placeholders in the 3D virtual environment.

It will be appreciated that user terminal 200 and server 300 may each comprise one or more processors and/or memory. As previously described, in embodiments, user terminal 200 comprises a processor 201 and associated memory 203. Processor 201 and associated memory 203 may be configured to perform one or more of the above-described functions of user terminal 200. Similarly, in embodiments, server 300 comprises a processor 313 and associated memory 315. Processor 313 and associated memory 315 may be configured to perform one or more of the above-described functions of server 300. Each device, module, component, machine or function as described in relation to any of the examples described herein (for example, content identification module 303, analytics engine 311, receiver modules 215, 301, and transmitter modules 211, 309) may similarly comprise a processor or may be comprised in apparatus comprising a processor. One or more aspects of the embodiments described herein comprise processes performed by apparatus. In some examples, the apparatus comprises one or more processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also include computer programs, particularly computer programs on or in a carrier, adapted for putting the above-described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The one or more processors of user terminal 200 and/or server 300 may comprise a central processing unit (CPU). The one or more processors may comprise a graphics processing unit (GPU). The one or more processors may comprise one or more of a field programmable gate array (FPGA), a programmable logic device (PLD), or a complex programmable logic device (CPLD). The one or more processors may comprise an application specific integrated circuit (ASIC). It will be appreciated by the skilled person that many other types of device, in addition to the examples provided, may be used to provide the one or more processors. The one or more processors may comprise multiple co-located processors or multiple disparately located processors. Operations performed by the one or more processors may be carried out by one or more of hardware, firmware, and software.

The one or more processors may comprise data storage. The data storage may comprise one or both of volatile and non-volatile memory. The data storage may comprise one or more of random access memory (RAM), read-only memory (ROM), a magnetic or optical disk and disk drive, or a solid-state drive (SSD). It will be appreciated by the skilled person that many other types of memory, in addition to the examples provided, may also be used. It will be appreciated by a person skilled in the art that the one or more processors may each comprise more, fewer and/or different components from those described.

The techniques described herein may be implemented in software or hardware, or may be implemented using a combination of software and hardware. They may include configuring an apparatus to carry out and/or support any or all of techniques described herein. Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. The carrier may comprise a computer readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

What is claimed is:

1. A method of processing 3D virtual environment data, the method comprising, at a server:
receiving, from a user terminal remote from the server, a request for one or more virtual content assets for use in populating one or more virtual content asset placeholders within a 3D virtual environment currently being executed on the user terminal;
in response to receipt of the request, identifying from a store of virtual content assets, for each of the one or more virtual content asset placeholders, at least one virtual content asset that satisfies one or more rules associated with the respective virtual content asset placeholder or the at least one virtual content asset; and
transmitting, to the user terminal, data associated with the identified at least one virtual content asset, the transmitted data being operable to cause the user terminal to populate the one or more virtual content asset placeholders in the 3D virtual environment currently being executed on the user terminal.

2. The method of claim 1, wherein:
the identifying comprises identifying a first virtual content asset and a second virtual content asset, and
the identifying of the second virtual content asset is dependent on the identifying of the first virtual content asset.

3. The method of claim 1, further comprising:
receiving, from the user terminal, data associated with an engagement of an end-user with the at least one virtual content asset within the 3D virtual environment; and
based on the received data associated with the engagement, modifying the one or more rules.

4. The method of claim 3, wherein the data associated with the engagement is associated with one or more of:
the end-user looking at the at least one virtual content asset,
the end-user interacting with the at least one virtual content asset,
the end-user performing an action associated with the at least one virtual content asset outside the 3D virtual environment, and
a location of the end-user within the 3D virtual environment.

5. The method of claim 3, wherein modifying the one or more rules includes associating an additional rule with one or more virtual content asset placeholders.

6. The method of claim 3, wherein modifying the one or more rules includes disassociating a rule from one or more virtual content asset placeholders.

7. The method of claim 3, wherein the receiving of the data associated with the engagement and the modifying of the one or more rules are performed while the 3D virtual environment is being executed on the user terminal.

8. The method of claim 3, further comprising repeating the receiving, the identifying, and the transmitting in response to an additional request for one or more additional virtual content assets for use in populating one or more additional virtual content asset placeholders within the 3D virtual environment,
wherein the identifying performed in response to the additional request is performed based on the modified one or more rules.

9. The method of claim 8, wherein the identifying in response to the additional request is performed at least partly based on one or more previously identified virtual content assets.

10. The method of claim 1, wherein the request comprises data identifying the one or more virtual content asset placeholders.

11. The method of claim 10, further comprising, in response to receipt of the request, retrieving, from a database, the one or more rules associated with the identified one or more virtual content asset placeholders, wherein the identifying is performed in response to the retrieval.

12. The method of claim 1, further comprising, prior to receipt of the request:
receiving user input indicating the one or more virtual content asset placeholders and defining the one or more rules; and
in response to receipt of the user input, associating the one or more rules with the one or more virtual content asset placeholders.

13. The method of claim 1, wherein the one or more rules are associated with one or more of:
a profile of an end-user,
historical behavior of an end-user,
a characteristic of the one or more virtual content assets,
a characteristic of the one or more virtual content asset placeholders, and
a date and/or time of the request.

14. The method of claim 1, wherein the at least one virtual content asset comprises one or more of:
3D virtual object data,
image data,
text data,
audio data, and
video data.

15. The method of claim 1, wherein the 3D virtual environment comprises one or more of:
a virtual reality application,
an augmented reality application,
a mixed reality application, and
a 3D application for display on a 2D display.

16. A server for processing 3D virtual environment data, the server comprising:
a receiver module configured to receive, from a user terminal remote from the server, a request for one or more virtual content assets for use in populating one or more virtual content asset placeholders within a 3D virtual environment currently being executed on the user terminal;
a content identification module configured to, in response to receipt of the request, identify from a store of virtual content assets, for each of the one or more virtual content asset placeholders, at least one virtual content asset that satisfies one or more rules associated with the respective virtual content asset placeholder or the at least one virtual content asset; and
a transmitter module configured to transmit, to the user terminal, data associated with the identified at least one virtual content asset, the transmitted data being operable to cause the user terminal to populate the one or more virtual content asset placeholders in the 3D virtual environment currently being executed on the user terminal.

17. A method of processing 3D virtual environment data, the method comprising, at a user terminal:
executing a 3D virtual environment;
transmitting, to a remote server, a request for one or more virtual content assets for use in populating one or more virtual content asset placeholders within the 3D virtual environment being executed;
receiving, from the remote server, for each of the one or more virtual content asset placeholders, data associated with one or more virtual content assets, the one or more virtual content assets having been identified as satisfying one or more rules associated with the respective virtual content asset placeholder or the one or more virtual content assets; and
in response to receipt of the data, populating the one or more virtual content asset placeholders in the 3D virtual environment.

18. The method of claim 17, wherein the transmitting of the request is performed in response to one or more of:
the executing of the 3D virtual environment,
a proximity in the 3D virtual environment of an end-user to one or more virtual content asset placeholders,
engagement by the end-user with one or more virtual content assets, and
an interaction by the end-user with the 3D virtual environment.

19. The method of claim 17, comprising:
monitoring an engagement by an end-user with one or more virtual content assets within the 3D virtual environment; and
in response to the monitoring, transmitting, to the remote server, data associated with the engagement.

20. The method of claim 17, wherein the user terminal comprises a display and wherein the executing and populating comprise displaying the 3D virtual environment, including the identified one or more virtual content assets, on the display.
